(19) United States
(12) Patent Application Publication
(10) Pub. No.: US 2010/0300792 A1
(43) Pub. Date: Dec. 2, 2010

(54) AIRBAG APPARATUS FOR PEDESTRIAN PROTECTION

(76) Inventors: Liang-Yann Yuan, Taipei City (TW); Ten-Sui Lin, Banqiao City (TW); Ke-Cheng Yu, Longtan Shiang (TW)

Correspondence Address: Dr. BANGER SHIA;Patent Office of Bang Shia, 102 Lindencrest Ct, Sugar Land, TX, 77479-5201, US

(21) Appl. No.: 12/474,269

(22) Filed: May 28, 2009

(51) Int. Cl. B60T 7/22

(52) U.S. Cl. 180/274

(57) ABSTRACT

The invention provides an airbag apparatus for pedestrian protection disposed below a rear portion of a hood and near a windshield of an automobile. The airbag apparatus includes an inflator, an airbag, a receiver and an air-guiding tube. The airbag includes a main bag portion with a plurality of air rooms. The receiver, fixed below the rear portion of the hood, is for the receiving of the airbag with a guiding opening. The air-guiding tube is connected with the inflator and disposed inside the airbag. The air-guiding tube has a peripheral surface on which a plurality of flow-distributing holes corresponding to the air rooms are formed. Thereby, air supplied by the inflator can flow into the airbag through the flow-distributing holes such that the airbag thrusts out from the guiding opening of the receiver to the windshield and covers the windshield and two pillars adjacent to the windshield.

### BACKGROUND OF THE INVENTION

1. Field of the invention

This invention relates to an airbag apparatus, and more particularly, to the airbag apparatus which can be applied to an automobile for protecting the pedestrian which is hit by the automobile.

2. Description of the related art

In recent years, people are used to the idea of driving automobiles as a transportation mode. To enhance the safety of the drivers, automobiles are usually equipped with airbags before leaving the factory for better protection of the drivers. However, a driver's responsibility not only includes protecting the drivers' safety, but also observing road rules all the time.

Since the popularity of driving increases and the roads are crowded with cars and people (especially in the cities, in which the popularity density is very large), car accidents occur frequently and make people injured or die. Generally, when a pedestrian is hit by a car, the lower half of his body will be hit first. So, after being hit by a car, the pedestrian will roll on to the hood and be hit by the hood and then by the windshield or the other body structure of the car made of material of greater stiffness (e.g., two pillars adjacent to the windshield), which make the pedestrian severely injured or die.

Traffic accidents occur frequently nowadays. Although new cars are always equipped with airbags for protecting the driver, protecting equipment for pedestrians is rarely installed on the cars. Therefore, there still exist some progresses to improve on the protecting equipment of the cars to reduce the injuries and deaths in traffic accidents.

### SUMMARY OF THE INVENTION

In view of the above-mentioned problems, a scope of the invention is to provide an airbag apparatus.

According to an embodiment of the invention, the airbag apparatus includes an inflator, an airbag, a receiver, and an air-guiding tube.

The inflator is for providing an air. The airbag includes a main bag portion, and the main bag portion has a plurality of first air rooms. The receiver is for receiving the airbag and has a guiding opening. The air-guiding tube is connected with the inflator and disposed inside the airbag, wherein the air-guiding tube has a peripheral surface on which a plurality of flow-distributing holes corresponding to the first air rooms are formed. Thereby, the air which is provided by the inflator flows into the airbag through the flow-distributing holes such that the airbag thrusts out from the guiding opening.

In an embodiment, the airbag apparatus according to the invention can be disposed below a rear portion of a hood and near a windshield of an automobile.

In the embodiment, the airbag apparatus includes an inflator, an airbag, a receiver, and an air-guiding tube.

The inflator is for providing an air. The airbag includes a main bag portion, and the main bag portion has a plurality of first air rooms. The receiver is fixed below the rear portion of the hood and is for receiving the airbag and has a guiding opening. The air-guiding tube is connected with the inflator and disposed inside the airbag, wherein the air-guiding tube has a peripheral surface on which a plurality of flow-distributing holes corresponding to the first air rooms are formed.

Thereby, the air provided by the inflator will flow into the airbag through the flow-distributing holes such that the airbag thrusts out from the guiding opening of the receiver to the windshield and the main bag portion deploys up and covers on a lower region of the windshield.

The advantage and spirit of the invention may be understood by the following recitations together with the appended drawings.

### BRIEF DESCRIPTION OF THE APPENDED DRAWINGS

FIG. 1 is a schematic diagram illustrating an airbag apparatus according to an embodiment of the invention.

FIG. 2A and FIG. 2B are schematic diagrams illustrating a receiver of the airbag apparatus in an embodiment.

FIG. 3 is a view illustrating an exploded inflator and an air-guiding tube of the airbag apparatus in an embodiment.

FIG. 4 is a schematic diagram illustrating that the airbag apparatus according to the invention is applied to an automobile.

### DETAILED DESCRIPTION OF THE INVENTION

The main scope of the invention is to provide an airbag apparatus. In practical application, the airbag apparatus of the invention can be applied in an automobile, which can especially protect pedestrians while they are being hit by the automobile.

In order to describe the idea of the invention adequately, an embodiment of applying the airbag apparatus in the automobile will be taken as an example and described in detail.

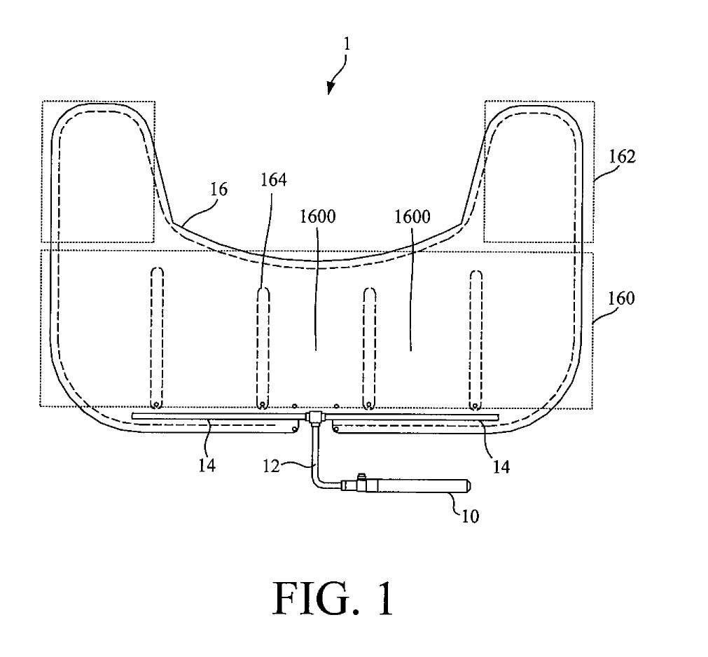

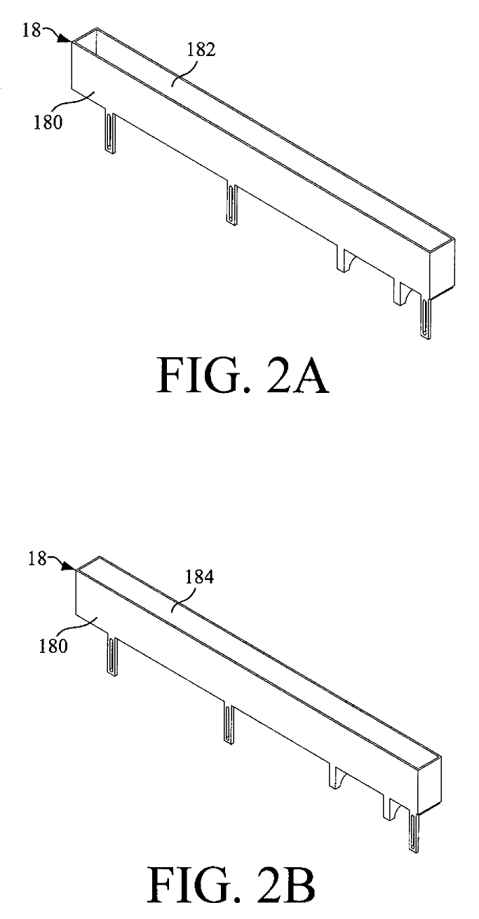

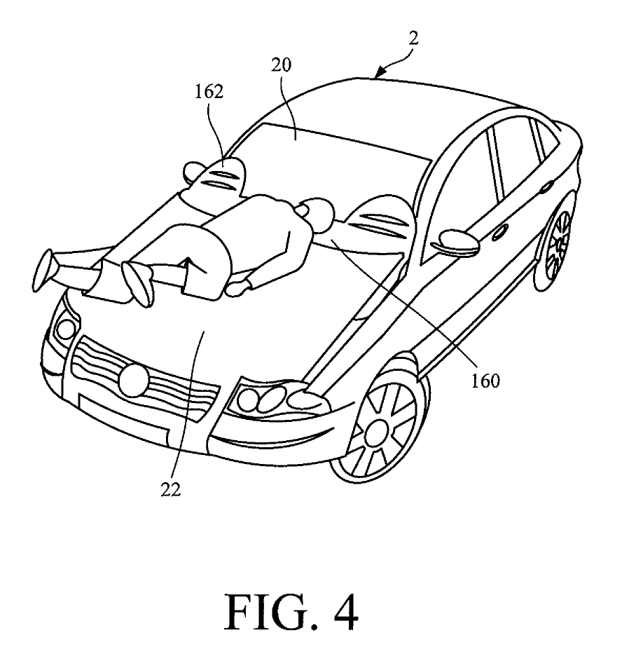

Firstly, please refer to FIG. 1, FIG. 2A, FIG. 2B and FIG. 4. FIG. 1 is a schematic diagram illustrating an airbag apparatus 1 according to an embodiment of the invention. FIG. 2A and FIG. 2B are schematic diagrams illustrating a receiver of the airbag apparatus in an embodiment. FIG. 4 is a schematic diagram illustrating that the airbag apparatus according to the invention is applied to an automobile 2.

As shown in FIG. 1, FIG. 2A, FIG. 2B and FIG. 4, the airbag apparatus in the embodiment includes an inflator 10, an airbag 16, a receiver 18, and air-guiding tubes 12, 14. The airbag apparatus according to the invention can be disposed below a rear portion of a hood 22 and near a windshield 20 of an automobile 2. Therefore, the airbag apparatus of the invention does not need additional space to be disposed in the automobile 2. So the airbag apparatus is endowed with practical utility.

In practical application, the inflator 10 can be a high-pressure gas cylinder for providing a high pressure air. As shown in FIG. 1, the airbag 16 includes a main bag portion 160, and the main bag portion 160 has a plurality of air rooms 1600. The airbag 16 can be made of nylon or other materials which are flexible and impact-resisting. Besides the main bag portion 160, the airbag 16 further includes two side airbag portions 162 which extend out of two ends of the main bag portion 160, as shown in FIG. 1. Similar to the main bag portion 160, each side airbag portion 162 can also has a plurality of air rooms.

As shown in FIG. 1, the main bag portion 160 of the airbag 16 has a plurality of closed sutures 164. Because it is hard for air to enter the portions with the sutures 164 of the main bag portion 160 after the airbag 16 is inflated and the portions without sutures 164 can be inflated to expand, the sutures 164 can be used to divide a plurality of air rooms 1600 from the main bag portion 160, wherein the air rooms 1600 partially internal to each other.

As shown in FIG. 2A, the receiver 18 has a seal plate 180. In an embodiment, the seal plate 180 can be formed in the shape of I.E., such that the receiver 18 has a guiding opening 182. Additionally, as shown in FIG. 2B, the receiver 18 can be equipped with a seal lid 184 for covering the guiding opening 182 to make the airbag 16 able to be packed in an airtight space which is formed by the seal plate 180 and the seal lid 84 after being folded. In practice, the seal lid 184 can be formed as a thin slice in advance. When the airbag 16 is inflated, the pressure is big enough to thrust out the seal lid 184 to make the airbag 16 able to leave the guiding opening 182 and be inflated continuously.

Particularly, the receiver 18 is disposed below the rear portion of the hood 22, and the guiding opening 182 faces the windshield 20 of the automobile 2. In practical application, the seal plate 180 of the receiver 18 needs to be made of the materials which can resist the huge pressure when the airbag 16 is inflated, such as metals and plastics with high hardness, etc. Thereby, the seal plate 180 will substantially keep its original shape while being impacted by the airbag 16, to keep the guiding opening 182 facing the windshield 20.

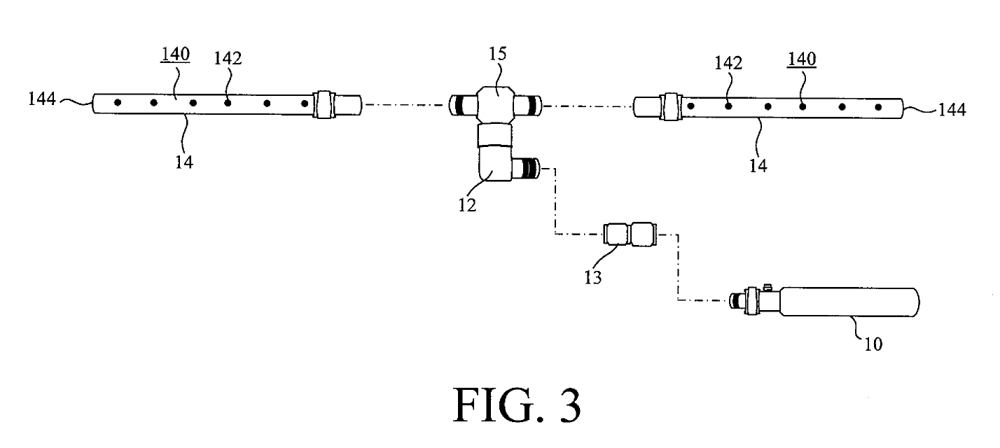

Please refer to FIG. 3. FIG. 3 is an exploded inflator 10 and an air-guiding tube (12, 14) of the airbag apparatus in an embodiment.

As shown in FIG. 3, the inflator 10 and an elbow-shaped air-guiding tube 12 can be fixed to a connecting member 13 (e.g., a nut) to connect to each other. Additionally, the elbow-shaped air-guiding tube 12 and two long-shaped air-guiding tubes 14 can be fixed and connected to each other by using a tripartite attachment 15. It is notable that each long-shaped air-guiding tube 14 has a peripheral surface 140 and a plurality of flow-distributing holes 142 are disposed on the peripheral surface 140. With regard to the forming positions of the flow-distributing holes 142, the flow-distributing holes 142 can be formed corresponding to the air rooms 1600 of the main bag 160. Besides forming the flow-distributing holes 142 on the peripheral surface 140, the ends of two air-guiding tubes 14 can have an opening 144 corresponding to the two side airbag portions 162.

Particularly, each flow-distributing hole 142 of each long-shaped air-guiding tube 14 can correspond to one air room 1600 of the main bag portion 160. Or, at least two flow-distributing holes 142 of each air-guiding tube 14 can correspond to one air room 1600 of the main bag portion 160.

Additionally, the size of each flow-distributing hole 142 can be determined according to an airflow pressure of the air which flows toward each flow-distributing hole 142. For example, since the airflow pressure will decrease with longer flow distance (i.e. Tie airflow pressure will gradually reduce along the outside of the air-guiding tube 14), the size of the flow-distributing hole 142 of the long-shaped air-guiding tube 14 can gradually reduce from the inside to the outside of the long-shaped air-guiding tube 14 to uniformly inflate the airbag 16.

Alternatively, the size of each flow-distributing hole 142 can be determined according to the size of an air room 1600 which correspond to each flow-distributing hole 142. For example, if the air room 1600 which correspond to a certain flow-distributing hole 142 is larger, the size of the flow-distributing hole 142 can be designed to be larger compared with other flow-distributing holes 142 to uniformly inflate the airbag 16.

Thereby, the air which is provided from the inflator 10 can flow into the airbag 16 through the flow-distributing holes 142 such that the airbag 16 thrusts out from the guiding opening 182 of the receiver 18. It is notable that the exploded view in FIG. 3 is illustrated just for an example. The shape and the number of the air-guiding tube (12, 14) and the connection relationship between the air-guiding tube (12, 14) and the inflator 10 can cover every kind of possible changes and alternatives.

The sections above mainly introduce the structure of each unit and the connecting relationships among the airbag apparatus of the invention. Descriptions of the airbag apparatus that is practically applied in the automobile will be fully explained below.

It is notable that the automobile which adopts the airbag apparatus of the invention can be installed with a pedestrian hitting sensor system in the bumper in advance, including a hitting sensor unit and an electronic control unit (ECU) which electronically connects to the hitting sensor unit.

When a pedestrian is hit by the automobile, the hitting sensor will transmit a perception signal to the ECU. After determining that the collision force and the features comply with the situation when a pedestrian is hit, the electronic control unit can automatically open the rear portion of the hood 22 (as shown in FIG. 4). Additionally, the electronic control unit can transmit a trigger command and actuate the igniter by the high voltage circuit provided by the power of the automobile. By breaking through the seal lid of the high pressure steel bottle with a strike apparatus, the high pressure air will thrust out. The automobile with the hitting sensor system can be easily achieved and applied by one with ordinary skill in the art, so they will not be redundantly explained here.

Afterwards, high pressure air can flow along the foregoing elbow-shaped air-guiding tube 12 to the tripartite attachment 15 instantly and then flow into two air-guiding tubes 14 from the tripartite attachment 15. Then, the high pressure air can flow into the airbag 16 to inflate via the flow-distributing holes 142, such that the airbag 16 thrusts out from the guiding opening 182 of the receiver 18 to the windshield 20.

As shown in FIG. 4, the main bag portion 160 of the airbag 16 can deploy up and covers a lower region of the windshield 20. By observing FIG. 4 in detail, the upper region of the main bag portion 160 can cover the lower region of the windshield 20.

According to the statistics data, the chance that the head of the pedestrian hits the rear portion of the hood 22 and the lower region of the windshield 20 near the windscreen wiper after being hit is less, so the lower region of the main bag portion 160 is divided into air rooms 1600 with the sutures and only provides less air to protect. Thus, the most air can flow to the windshield 20 along the air rooms 1600 among the sutures and inflates the upper region of the main bag portion 160, so as to achieve the effect of quick inflation.

It can be known with the above descriptions that the airbag 16 of the invention not only can save the air to make the best usage but also can make the inflator 10 finish the deployment of the airbag 16 in the shortest time, so as to save the pedestrian while being hit.

Besides that the main bag portion 160 can cover on the lower region of the windshield 20, two side airbag portions 162 which extend out of two ends of the main bag portion 160 can deploy up and cover the two pillars adjacent to the windshield 20 respectively. The function of the side airbag portion 162 is to deploy and provide protection when the pedestrian is hit by the automobile and his head hits one of the side pillars to reduce the possibility of injury and death. In practical application, the end opening 144 of each long-shaped air-guiding tube 14 can be designed to be larger to quickly inflate the side airbag portion 162 of the pillars.

Additionally, the deployment airbag 16 can be located out of a viewing area of the driver of the automobile for saving the driver's safety. As shown in FIG. 1, the deployment airbag 16 can be U-shaped, so the field of view of the driver (as shown in FIG. 4) will not be obstructed and the subsequent hit can be prevented or deduced.

To sum up, the airbag apparatus of the invention can be applied in an automobile, and the protection region of the airbag covers the lower region of the windshield and the regions of the two side pillars adjacent to the windshield. Therefore, when a pedestrian is hit by an automobile, the airbag apparatus of the invention can provide complete protections for reducing the probability of injuries and death.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as being limited only by the metes and bounds of the appended claims.

What is claimed is:

1. An airbag apparatus for the pedestrian protection disposed below a rear portion of a hood and near a windshield of an automobile, the airbag apparatus comprising:
an inflator for providing an air;
an airbag comprising a main bag portion with a plurality of first air rooms;
a receiver, fixed below the rear portion of the hood, for receiving the airbag and having a guiding opening; and
an air-guiding tube, connected with the inflator and disposed inside the airbag, wherein the air-guiding tube has a peripheral surface on which a plurality of flow-distributing holes corresponding to the first air rooms are formed;
wherein the air flows into the airbag through the flow-distributing holes such that the airbag thrusts out from the guiding opening of the receiver to the windshield and the main bag portion deploys up and covers a lower region of the windshield.

2. The airbag apparatus of claim 1, wherein the airbag comprises two side airbag portions which extend out of two ends of the main bag portion, the two side airbag portions deploy up and cover the two pillars adjacent to the windshield respectively.

3. The airbag apparatus of claim 2, wherein an end of the air-guiding tube has an opening, the air flows into the two side airbag portions through the opening.

4. The airbag apparatus of claim 2, wherein each side airbag portion further has a plurality of second air rooms.

5. The airbag apparatus of claim 1, wherein the first air rooms are disposed inside a lower portion of the main bag portion.

6. The airbag apparatus of claim 1, wherein the deployment main bag portion is located out of a viewing area of the driver of the automobile.

7. The airbag apparatus of claim 1, wherein the size of each flow-distributing hole is determined according to an airflow pressure of the air which flows toward the flow-distributing hole.

8. The airbag apparatus of claim 1, wherein the size of each flow-distributing hole is determined according to the size of a first air room corresponding to the flow-distributing hole.

9. The airbag apparatus of claim 1, wherein the main bag portion has a plurality of sutures for dividing the first air rooms.

10. The airbag apparatus of claim 1, wherein the receiver has a lid for covering the guiding opening, the airbag can be packed inside a close space of the receiver after the airbag is folded, and the airbag thrusts out from the lid when the pressure of the inflated air is sufficient.

11. An airbag apparatus, comprising:
an inflator for providing air;
an airbag comprising a main bag portion with a plurality of first air rooms;
a receiver for receiving the airbag with a guiding opening; and
an air-guiding tube, connected with the inflator and disposed inside the airbag, wherein the air-guiding tube has a peripheral surface on which a plurality of flow-distributing holes corresponding to the first air rooms are formed, and the air flows into the airbag through the flow-distributing holes such that the airbag thrusts out from the guiding opening.

12. The airbag apparatus of claim 11, wherein the airbag comprises two side airbag portions which extend out of two ends of the main bag portion.

13. The airbag apparatus of claim 12, wherein an end of the air-guiding tube has an opening, the air flows into the two side airbag portions through the opening.

14. The airbag apparatus of claim 12, wherein each side airbag portion further has a plurality of second air rooms.

15. The airbag apparatus of claim 11, wherein the size of each flow-distributing hole is determined according to an airflow pressure of the air which flows toward the flow-distributing hole.

16. The airbag apparatus of claim 11, wherein the size of each flow-distributing hole is determined according to the size of a first air room corresponding to the flow-distributing hole.

17. The airbag apparatus of claim 11, wherein the main bag portion has a plurality of sutures for dividing the first air rooms.

18. The airbag apparatus of claim 11, wherein the receiver has a lid for covering the guiding opening, the airbag can be packed inside a close space of the receiver after the airbag is folded, and the airbag thrusts out from the lid when the pressure of the inflated air is sufficient.
